(19) United States
(12) Patent Application Publication
(10) Pub. No.: US 2023/0311475 A1
(43) Pub. Date: Oct. 5, 2023

(54) A METHOD AND SYSTEM FOR PRINTING

(71) Applicant: Tetra Laval Holdings & Finance S.A., Pully (CH)

(72) Inventors: Sverker OLSSON, Södra Sandby (SE); Johannes ALENIUS, Kristianstad (SE)

(21) Appl. No.: 18/043,489

(22) PCT Filed: Aug. 30, 2021
(86) PCT No.: PCT/EP2021/073852

§ 371 Date: Feb. 28, 2023

(30) Foreign Application Priority Data
Sep. 3, 2020 (EP) 20194441.0

(51) Int. Cl. B41F 13/02; B41F 5/24

(52) U.S. Cl. CPC B41F 13/02; B41F 5/24

(57) ABSTRACT

A printing station for use in a packaging material manufacturing system is provided. The printing station comprises a printing unit being configured to provide a print at a pre-set position on the packaging material, a detecting unit arranged downstream the printing unit and configured to determine the actual lateral distance between a reference position and the provided print, and a control unit being configured to store a desired lateral distance between the print and the reference position, and to adjust the pre-set position of a subsequent print based on a comparison between a desired lateral distance and the actual lateral distance.

### TECHNICAL FIELD

The invention relates to a method and a system for printing. In particular, the present invention is related to a solution for controlling the position of printed objects in high speed production of packaging material.

### BACKGROUND ARTS

Packaging containers of the single use disposable type for foods (for instance liquid or semi-liquid) are often produced from a packaging material based on paperboard or carton. The packaging material of this known packaging container is typically manufactured as a laminate comprising a bulk layer of paper or paperboard and outer, liquid-tight layers of thermoplastics.

On the inside of the laminate, i.e. the side intended to face the filled food contents of a packaging container produced from the laminate, there is one or more inner layers comprising heat sealable thermoplastic polymers.

The laminate may also have a barrier layer to avoid light and/or gas penetration to inside of the packaging container, for instance a metal layer like aluminum.

The appearance of packaging containers manufactured from the above-described packaging material is dependent on a décor printed on an outer layer of the packaging material, forming an exterior side of the packaging container. The printed décor is conventionally applied by means of high-speed flexography processes. These printing processes are designed for high-speed printing of wide substrate webs of several meters in e.g. packaging material manufacturing plants.

For every color to be printed by flexography, a printing plate is made and mounted on the circumference of a rotatable printing cylinder. For packaging material manufacturing, the printing plate contains a repeat of the pattern to be printed. The repeat length, which equals the circumference of the printing cylinder when the printing plate is mounted thereto, may typically correspond to 3-6 packaging container prints and may vary e.g. between 450 and 800 mm.

The width of the printing plate is typically selected so that a décor is printed on multiple lanes at the same time; each lane will eventually be separated and used in a packaging container manufacturing machine. Hence, the web of packaging material entering the flexography process will be provided with a repetitive printed pattern, each printed pattern being designed for a single packaging container to be produced.

In order to increase printing speed the printing plate width may correspond to twelve lanes. Consequently, as the printing plate is performing one revolution the packaging material will be provided with a printed pattern on an area corresponding to up to 12*6 packaging container to be produced.

The configuration of the printing plate is static, which means that the printed pattern will be the same for all packaging containers being produced using the same printing plate. However, during recent years it has been suggested to also provide a dynamic print on the packaging material which can be accessed by a consumer of the produced packaging containers. As one example, the dynamic print can be a two-dimensional code containing specific information.

Such dynamic prints cannot be obtained using existing flexography processes due to its repetitive character. Instead it has been suggested to provide a separate printing station downstream the flexography processing equipment. The separate printing station is capable of providing unique prints inline, e.g. by implementing inkjet technology, thereby allowing unique two-dimensional codes or other dynamic objects to be printed at areas of the packaging material; typically, each final packaging container will have a dynamic print.

The position of the dynamic print, i.e. the pattern printed by the separate printing station, must be in register such that it is aligned with the print of the flexography process. In order to allow readability of the dynamic print the flexography design may include a specific area, which typically is non-printed or provided with a specific background color, for accommodating the dynamic print. Should the position of the dynamic print be misaligned, there is a great risk that correct reading of the dynamic print is made impossible or at least made more difficult.

Correct positioning of the dynamic print is affected by several parameters. One important factor is that the packaging material may be subject to changes in dimensions as it travels through the packaging material manufacturing plant, and especially through the décor printing equipment including the separate printing station. For example, wrinkles may be present which will possibly require adjustment of the position of the dynamic print. Another issue that will affect packaging material web dimensions is humidity, and moisture content of the packaging material. Especially thin packaging materials will expand and retract laterally as the moisture content changes, e.g. due to drying heat applied immediately after the flexography process. Due to the considerably large web width, as previously mentioned up to 12 lanes, any variations in packaging material width may cause faulty positioning of the dynamic print, especially at the outer lanes. A further factor that needs to be considered is lateral movement of the web of packaging material. Such movement is commonly known as snaking, and causes small shifts of the lateral positioning of the entire web of packaging material.

All these factors will possibly affect the positioning of prints relative the décor of the packaging material.

There is thus a need for an improved method and system for printing which ensures correct positioning of a printed pattern in relation to already-present features on the packaging material, even if the dimensions or the position of the packaging material will vary during production.

### SUMMARY

It is an object of the invention to at least partly overcome one or more of the above-identified limitations. In particular, it is an object to automatically determine the correct position of an object to be printed, as well as to adjust a dedicated printing unit so that the object is printed at the desired position on the packaging material web.

To solve these objects a printing station is provided. The printing station is arranged to be used in a packaging material manufacturing system, and comprises a printing unit being configured to provide a print at a pre-set position. The printing station is further comprising a detecting unit arranged downstream the printing unit and configured to determine the actual lateral distance between a reference position and the provided print. A control unit is configured to store a desired lateral distance between the print and the reference position, and to adjust the pre-set position of a subsequent print based on a comparison between a desired lateral distance and the actual lateral distance.

There may be several printing units that may be controlled independently from each other.

The printing station has proven to be advantageous in that the position of the print can be determined based on already available reference features on the packaging material, and in that any misalignment of the print will be immediately detected and corrected for thereby effectively reducing the amount of defects of the packaging material.

The printing station, and methods using such printing station, is providing an in-line register system for lateral control for printing dynamic design elements and/or marks, such as two-dimensional codes, that will eventually be visible on packaging containers. The herein described printing station is supporting cost reduction, by significantly reducing set up time and waste. The printing station is used for closed loop lateral control of printing units and for inline individual lane shrinkage compensation. The printing station has proven to constantly print design elements at the desired position regardless of web shrinkage impact on individual lanes of the web of packaging material.

In an embodiment, the reference position is the actual position of a reference feature of the packaging material. Such reference feature may e.g. be a pre-printed object, such as a crease line print or a register mark. Preferably, the reference position may be determined as a lateral position corresponding to the edge, or corner, of the reference feature. Optionally, the reference position may be determined as a center position of the reference position.

The print may be a dynamic print, i.e. the design of the print is non-static such that it varies during printing operation. For example, two consecutive prints are not identical but varies to some extent. By allowing for dynamic prints, the print may be designed to provide information to a consumer. The information may be in clear text or numbers, however it is preferred to provide the information as a two-dimensional code, such as a QR code.

In an embodiment, the control unit is configured to adjust the pre-set position of a subsequent print by shifting the position of the printing unit. This has proven to be very robust, as linear motion of the printing unit can be controlled with extremely high accuracy.

The printing unit may comprise a plurality of laterally distributed printing devices, each printing device being configured to provide a print at a unique pre-set position. This is advantageous in that the printing unit can be used with wide webs of packaging material, being manufactured as several adjoining lanes. This also allows for dynamic prints distributed laterally, such that two laterally adjacent prints may be printed simultaneously by different printing devices, while the print design may vary.

The detecting unit may comprise a plurality of laterally distributed detecting devices, each detecting device being configured to determine the actual lateral distance between a unique reference position and a provided print. For wide webs of packaging material this has proven to be particularly advantageous. Especially when the lateral width of the web of packaging material is varying, e.g. as an effect due to varying moisture content of the packaging material, the adjustment of the pre-set positions is not necessarily constant across the width of the packaging material, i.e. for the different lanes. Hence, individual control of each of the pre-set positions is preferable and made available by the provision of several independent detecting devices.

According to a second aspect, a packaging material manufacturing system is provided. The packaging manufacturing system comprises a décor printing system and a printing station according to the first aspect. The printing station is arranged downstream the décor printing system.

According to a third aspect, a method for providing prints to a packaging material by means of a printing station is provided. The method comprises activating a printing unit to provide a print at a pre-set position on the packaging material, determining the actual lateral distance between a reference position on the packaging material and the provided print, and adjusting the pre-set position of a subsequent print based on a comparison between a desired lateral distance between the reference position and the provided print, and the actual lateral distance.

The method may further comprise feeding a continuous web of packaging material through the printing station, wherein activating the printing unit, determining the actual lateral distance, and adjusting the pre-set position are performed repeatedly. The printing station can thus be used in-line production, thereby allowing high printing speeds.

The packaging material may be provided with a plurality of consecutive reference features, each reference feature defining a unique reference position. Activating a printing unit to provide a print at a pre-set position on the packaging material is for such embodiment performed repeatedly for each reference feature passing the printing unit.

Activating the printing unit may comprise activating a plurality of laterally distributed printing devices, each printing device being configured to provide a print at a unique pre-set position.

Determining the actual lateral distance may be performed by activating a plurality of laterally distributed detecting devices, each detecting device being configured to determine the actual lateral distance between a unique reference position and a provided print.

According to a fourth aspect, a method for manufacturing a packaging material is provided. The method comprises feeding a web of packaging material through a décor printing system thereby providing the packaging material with a décor, and subsequently providing a print to the packaging material by performing the method according to the third aspect.

Still other objectives, features, aspects and advantages of the invention will appear from the following detailed description as well as from the drawings.

### BRIEF DESCRIPTION OF THE DRAWINGS

Embodiments of the invention will now be described, by way of example, with reference to the accompanying schematic drawings, in which

FIG. 1 is a schematic view of a packaging material manufacturing system according to an embodiment;

FIG. 2 is a schematic side view of a printing station according to an embodiment, forming part of a packaging material manufacturing system;

FIG. 3 is a photograph of a packaging material being provided with a décor and a dynamic print;

FIG. 4 is a schematic view of a method for a packaging material according to an embodiment;

FIG. 5 is a schematic view of a method for providing a dynamic print according to an embodiment;

FIG. 6 is a top view of a printing station according to an embodiment;

FIG. 7 is a schematic view of a packaging material being processed by a printing station according to a first embodiment; and

FIG. 8 is a schematic view of a packaging material being processed by a printing station according to a second embodiment.

### DETAILED DESCRIPTION

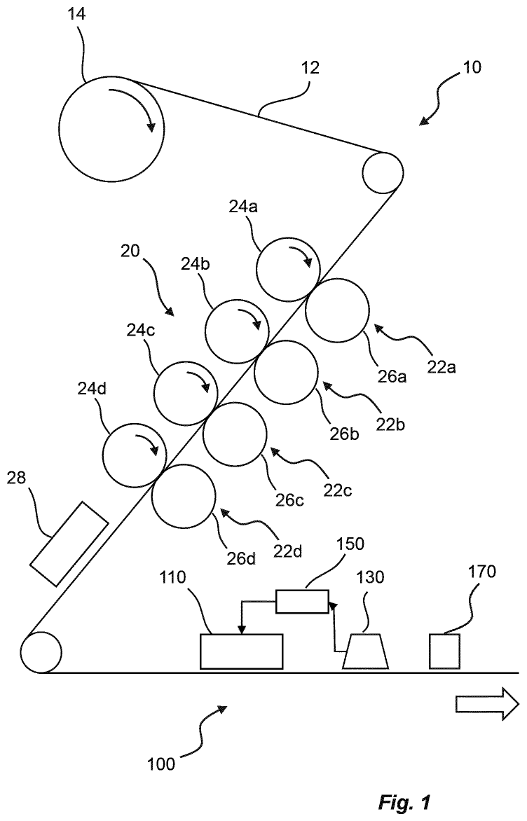

With reference to FIG. 1 a packaging material manufacturing system 10 is illustrated. The packaging material manufacturing system 10 comprises a décor printing system 20, and a printing station 100 arranged downstream the décor printing system 20.

A web of packaging material 12 is wound on a roll 14, and fed continuously through the packaging material manufacturing system 10 in the direction of the block arrow. The web of packaging material 12 is preferably pre-manufactured as a laminate comprising a bulk layer of paper or paperboard and outer, liquid-tight layers of thermoplastics, as well one or more inner layers comprising heat sealable thermoplastic polymers, and a barrier layer.

The décor printing system 20 is preferably a flexo printing system, comprising a series of flexo printing units 22a-d. Each flexo printing unit 22a-d comprises a plate cylinder 24a-d and an impression cylinder 26a-d. The plate cylinder 24a-d and the associated impression cylinder 26a-d forms a nip through which the web of packaging material 12 is fed through, thereby transferring ink from the plate cylinder 24a-d to the web of packaging material 12. In the shown example, four flexo printing units 22a-d are shown. Each flexo printing units 22a-d is responsible for a specific color; in one example, the flexo printing units 22a-d provide each one of the CMYK color scheme. Each flexo printing unit 22a-d may comprise additional components, such as anilox rollers and fountain rollers, as is well known in the art.

The décor printing system 20 is optionally provided with a drying unit 28. The drying unit 28 is arranged downstream the flexo printing units 22a-d. The drying unit 28 may operate by providing IR radiation or hot air to the web of packaging material 12, thereby drying the ink on the web of packaging material 12.

It should be noted that the décor printing system 20 may not necessarily be a flexo printing system, but other well-known techniques may be used as well for providing a décor to the web of packaging material 12.

Once the web of packaging material 12 is provided with the décor, it is passed through the printing station 100. The printing station 100 comprises a printing unit 110, a detecting unit 130 arranged downstream the printing unit 110, and a control unit 150. The control unit 150 is connected to the printing unit 110 and to the detecting unit 130, as illustrated by the arrows in FIG. 1. Optionally, the printing station 100 may further comprise a drying unit 170 arranged downstream the detecting unit 130. The drying unit 170 is preferably a hot air supply, directing the heated air stream towards the web of packaging material 12.

During operation, and as will be described further in detail below, the printing station 100 is configured to provide prints to the web of packaging material 12 in a repeated manner, as well as ensuring that the prints are aligned with the décor to a level of accuracy which has not been possible with prior art. Advantageously, the printing station 100 is arranged in-line with the upstream décor printing system 20.

As will be explained in the following, the printing station 100 allows for closed loop lateral control of the printing unit. The detecting unit 13, e.g. either provided as one or more line scanners or cameras, is configured to measure the distance between a fixed point in the décor design to the center of the print. A possible error correction is looped back to a position controller, i.e. the control unit 150, and all lanes are preferably inspected simultaneously.

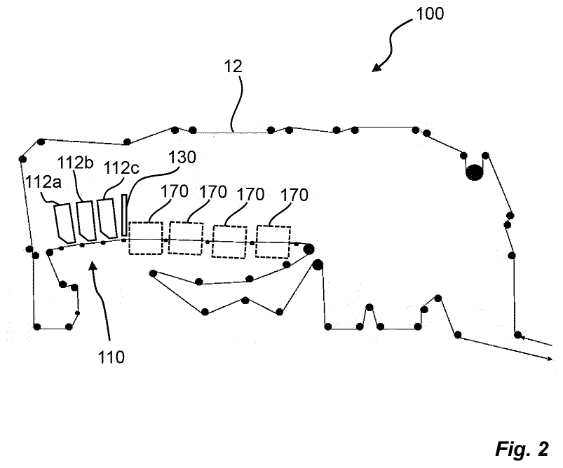

In FIG. 2 a more detailed example of a printing station 100 is shown. The web of packaging material 12 is transported across various rollers before passing the printing unit 110. The reason for not passing the printing unit 110 immediately after entering the printing station is not only for allowing accurate control of the tension of the web of packaging material 12, but also for allowing sufficient drying of the décor applied earlier in the packaging material manufacturing process, as well as allowing additional packaging material processing such as splicing, cleaning and dust removal, etc., to be performed within the printing station 100.

The printing unit 110 comprises one or more printing heads 112a-c spaced apart in the travel direction of the web of packaging material. The detecting unit 130 is arranged immediately downstream the printing unit 110, and upstream a series of hot air dryers 170. After exiting the printing station 100, the web of packaging material 12 is prepared for further handling such as cutting, winding, etc.

The printing station 100 allows for a novel and significantly improved combination of static décor printing and printing of dynamic content to a web of packaging material 12, especially with regards to accurate positioning of dynamic prints in relation to the design of the décor.

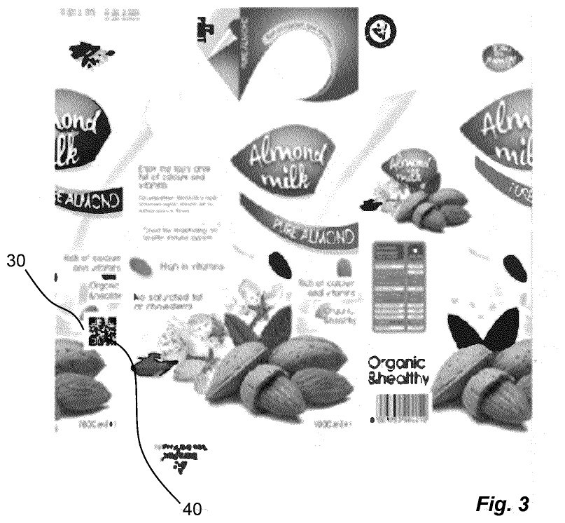

In FIG. 3 parts of a packaging material are shown. The photograph is showing the exterior side of the packaging material being printed with a décor in order to provide information and appealing design to the consumer. As shown in FIG. 3, the packaging material is manufactured to form packaging containers storing almond milk.

The décor design is covering the entire packaging material, and includes an area 30. Within this area 30, a two-dimensional code 40 is printed. In the shown example the area 30 has a bright color, while the two-dimensional code print 40 has a dark color. Due to the design of the décor, correct positioning of the printed code 40 is important for ensuring visibility and readability of the printed code 40. While the décor is printed using the décor printing system 20, the two-dimensional code 40 is printed using the printing station 100.

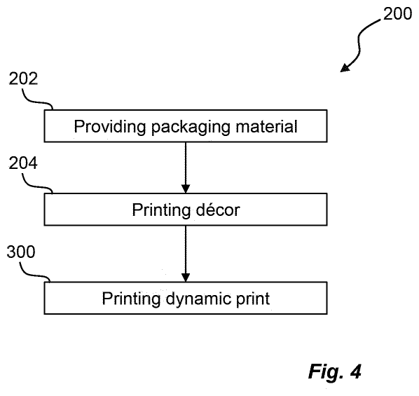

Now turning to FIG. 4, a general method 200 for manufacturing a packaging material will be briefly described. The method 200 is preferably performed by operating a packaging material manufacturing system 10 as described above. The method 200 comprises a first step 202 of providing a packaging material. The packaging material is preferably intended to be later formed, filled and sealed to individual liquid food packaging containers, and typically comprises a bulk layer of paper or paperboard and outer, liquid-tight layers of thermoplastics, as well one or more inner layers comprising heat sealable thermoplastic polymers. In a following step 204, a décor is printed to the exterior side of the packaging material. The décor is preferably designed with at least one area for accommodating a print, which is provided in a subsequent step 300.

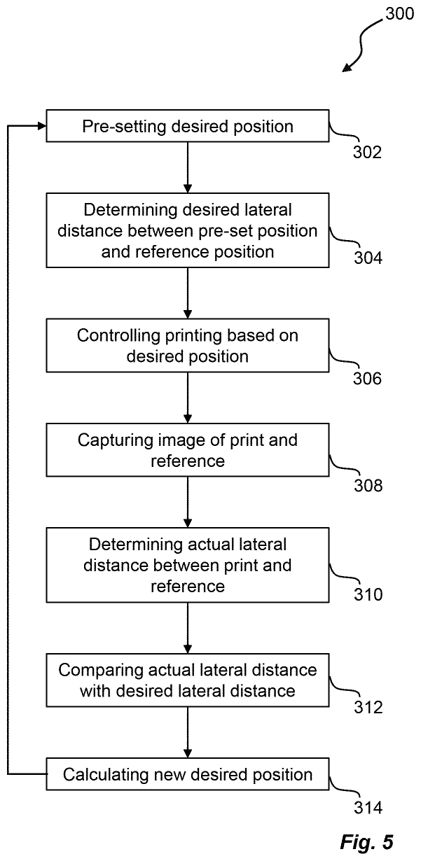

This subsequent step 300 of providing a print is further described with reference to FIG. 5, which provides a schematic illustration of a method for providing a print, such as a dynamic code, to the packaging material, after the décor is printed. Hence, the method 300 may form part of the method 200.

As a basic principle, the method 300 preferably operates by using features of the décor design as a reference for the dynamic print, and an in-line detection of the actual positioning of the dynamic print in relation to the décor reference. When detecting a misalignment of the dynamic print, the position of subsequent dynamic prints is adjusted. Hence, the method 300 applies a closed loop control of the position of the dynamic print.

Starting in step 302, a desired position of the print is determined. The desired position is stored as a pre-set position, and is preferably determined relative a 2D coordinate system. In this coordinate system, the position of a reference feature is well known such that the desired position of the print is set in relation to the reference feature. As will be explained below, the reference feature is preferably a décor feature of the packaging material.

In a step 304, the lateral distance between the pre-set position and the reference feature is determined as a desired lateral distance. This is done automatically without any visual inspection of the packaging material, as the position of the reference feature is available from a décor design file.

As the web of packaging material is transported through the printing station 100, in step 306 the print is provided at the desired pre-set position by activating the printing unit 110 of the printing station.

Once the print is provided in step 306, in step 308 image data is captured containing both the print and the reference feature.

From this image data, in step 310 the actual lateral distance between the print and the reference feature is determined. The actual lateral data is compared with the desired lateral distance in step 312, and any adjustment of the pre-set position is calculated in step 314. This newly calculated pre-set position is fed back to the initial step of the method 300, which is repeated continuously as operation of the printing station 100 is performed. Hence, any misalignment of the print will be detected immediately and correction will be performed by the closed loop control characteristics of the method 300.

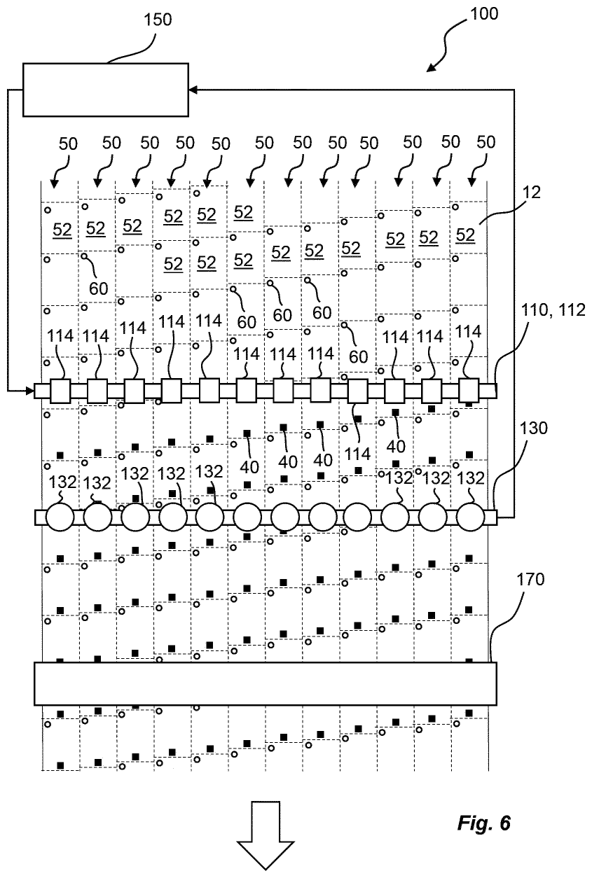

To further understand the functionality of the printing station 100, reference is made to FIG. 6. Here, a schematic illustration of the web of packaging material 12 is shown from above.

The packaging material 12 is assumed to be provided with a décor, and fed through the printing station 100 in the direction of the block arrow. As explained earlier, the printing station 100 comprises the printing unit 110, the detection unit 130, the control unit 150, and optionally the drying unit 170.

The width of the packaging material 12 is chosen such that packaging material 12 is divided into a plurality of lanes 50. The lanes 50 will eventually be separated to be used individually in a packaging container manufacturing machine, and each lane 50 has a width corresponding to the total width of the web of packaging material 12 required to form an individual packaging container. In the shown example, the web of packaging material has twelve lanes 50. The décor of each lane 50 is longitudinally divided into repeats 52. The web of packaging material 12 being covered by one single repeat 52 will eventually form a single packaging container.

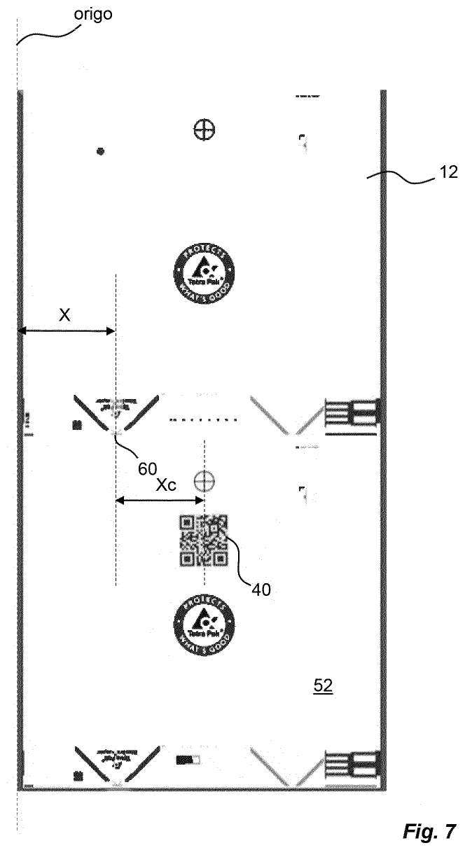

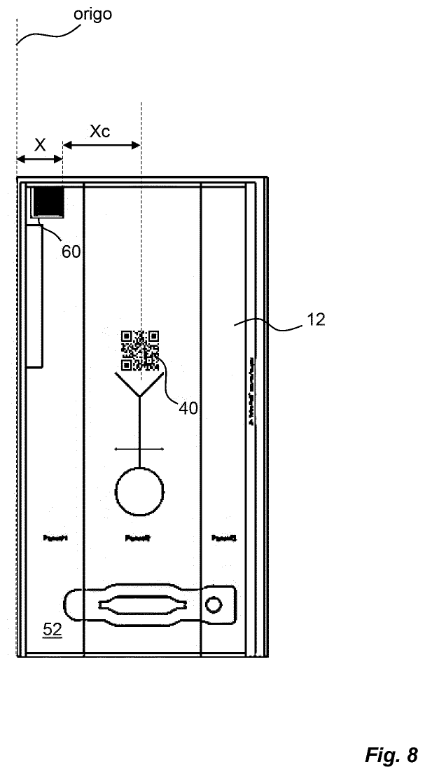

As can be seen in FIG. 6, the décor of each repeat 52 of each lane 50 is provided with a reference feature 60. This reference feature 60 can be of various types as explained further with reference to FIGS. 7 and 8, but should be detectable by the detection unit 130 as well as a having a well-defined position on the web of packaging material 12.

The printing unit 110 is here shown as a one printing head 112 extending across the width of the web of packaging material 12, i.e. across all lanes 50. It should however be realized, as indicated in FIG. 2, that the printing unit 110 may be formed by several longitudinally spaced apart printing heads 112.

The printing unit 110 comprises a plurality of printing devices 114 spaced apart laterally, i.e. along the width of the web of packaging material 12. Each printing device 114 is configured to provide a print 40 to the web of packaging material 12, and may e.g. be in the form of an inkjet printing device.

The control unit 150 is configured to control the operation of the printing devices 114. Activation of the printing device 114 is effected by determining the design of the print 40, as well as the position of the print 40. Due to the intrinsic characteristics of inkjet technology, the printing devices 114 are capable of varying the print design during operation of the printing station 100, such that the repeats 52 are provided with dynamic prints.

The position of each print 40 is determined by defining a pre-set position. The pre-set position is initially defined by the décor design, which typically may be provided with the area 30 (see FIG. 3) intended to carry the print 40. By defining the coordinate system in the plane of the web of packaging material 12 and by determining the assumed position of the web of packaging material 12 as well as the assumed position of the area 30, the lateral pre-set position of the print 40 is determined. Although not explained in further details herein, the longitudinal pre-set position of the print 40 is determined by determining the speed of the web of packaging material 12, setting the timing of activation of the printing devices 112, and adjusting the timing so that the print 40 is positioned correctly longitudinally.

The detection unit 130 is arranged downstream the printing unit 110 and comprises a plurality of detection devices 132. Each detection device 132 is preferably a camera configured to capture images of web of packaging material 12 as it passes under the detection devices 132. It should however by noted that the detection unit 130 may comprise only a single camera covering the entire width of the web of packaging material 12, i.e. all lanes 50.

From the captured images, for each repeat 52 the actual lateral distance between the print 40 and the reference feature 60 is calculated. The control unit 150 is further configured to compare the actual lateral distance with a desired lateral distance between the print 40 and the reference feature 60; this desired lateral distance is preferably determined from the décor design data. In case there is any deviance between the actual lateral distance and the desired lateral distance, the control unit 150 is configured to adjust the pre-set position of subsequent prints 40 so that these will be positioned correctly on the repeat 52.

Adjusting the pre-set position of the prints 40 is preferably performed by moving the printing unit 110 laterally to correct for the misalignment of the print 40 relative the décor, and in particular to the reference feature 60. In practice, for the embodiment using several printing devices 114, each printing device 114 is moveable individually and/or independently such that separate control of the position of the printing devices 114 is possible. For this, each printing device 114 may be provided with a drive unit (not shown) being capable of shifting the position of the associated printing device 114 laterally. Preferably, the drive unit is capable of adjusting the lateral position on a sub-mm level.

Examples of a repeat 52 are shown in FIGS. 7 and 8. These drawings show parts of a web of packaging material 12 having a printed décor, as well as a dynamic print 40.

Starting in FIG. 7, the origo is set at the lateral edge of the web of packaging material 12. The reference feature 60 is a printed K-mark, i.e. a specific mark used to identify the alignment of crease lines formed on the packaging material. When the packaging material is creased, the specific K-mark crease line is visually enhanced by printing the same K-mark design onto the crease line during the décor printing process. The lateral distance X between origo and the center of the K-mark is determined from the décor design data, and consequently also the desired lateral distance between the print 40 and the reference feature 60. While the actual lateral distance Xc is measured using the printing station 100, the measured lateral distance Xc is used for the control loop of the printing station 100.

In FIG. 8, the origo is also set at the lateral edge of the web of packaging material 12. The reference feature 60 is a register mark on the packaging material, preferably printed during the décor printing process. The lateral distance X between origo and the lateral end of the register mark 60 is determined from the décor design data, and consequently also the desired lateral distance between the print 40 and the reference feature 60 since this desired lateral distance is also determined by the décor design data. While the actual lateral distance Xc is measured using the printing station 100, the measured lateral distance Xc is used for the control loop of the printing station 100.

As mentioned above, the control parameter Xc is measured as the lateral distance between the print 40 and the reference feature 60. In one embodiment, the control parameter Xc is measured from the lateral end of the reference feature 60 to the center of the print 40. In another embodiment, the control parameter Xc is measured from the center of the reference feature 60 to the center of the print 40. In a yet further embodiment, the control parameter Xc is measured from the lateral end of the reference feature 60 to the lateral end of the print 40, or Xc is measured from the center of the reference feature 60 to the lateral end of the print 40.

From the description above follows that, although various embodiments of the invention have been described and shown, the invention is not restricted thereto, but may also be embodied in other ways within the scope of the subject-matter defined in the following claims.

1. A printing station for use in a packaging material manufacturing system, comprising
a printing unit being configured to provide a print at a pre-set position on the packaging material,
a detecting unit arranged downstream the printing unit and configured to determine the actual lateral distance between a reference position and the provided print, and
a control unit being configured to store a desired lateral distance between the print and the reference position, and to adjust the pre-set position of a subsequent print based on a comparison between a desired lateral distance and the actual lateral distance.

2. The printing station according to claim 1, wherein the reference position is the actual position of a reference feature of the packaging material.

3. The printing station according to claim 2, wherein the reference feature is a pre-printed object.

4. The printing station according to claim 3, wherein the pre-printed object is a crease line print or a register mark.

5. The printing station according to claim 1, wherein the print is a two-dimensional code.

6. The printing station according to claim 1, wherein the control unit is configured to adjust the pre-set position of a subsequent print by shifting the position of the printing unit.

7. The printing station according to claim 1, wherein the printing unit comprises a plurality of laterally distributed printing devices, each printing device being configured to provide a print at a unique pre-set position.

8. The printing station according to claim 1, wherein the detecting unit comprises a plurality of laterally distributed detecting devices, each detecting device being configured to determine the actual lateral distance between a unique reference position and a provided print.

9. A packaging material manufacturing system, comprising a décor printing system, and a printing station according to claim 1 arranged downstream the décor printing system.

10. A method for providing prints to a packaging material by means of a printing station, comprising:
activating a printing unit to provide a print at a pre-set position on the packaging material,
determining the actual lateral distance between a reference position on the packaging material and the provided print, and
adjusting the pre-set position of a subsequent print based on a comparison between a desired lateral distance between the reference position and the provided print, and the actual lateral distance.

11. The method according to claim 10, further comprising feeding a continuous web of packaging material through the printing station, wherein activating the printing unit, determining the actual lateral distance, and adjusting the pre-set position are performed repeatedly.

12. The method according to claim 11, wherein the packaging material is provided with a plurality of consecutive reference features, each reference feature defining a unique reference position, wherein activating a printing unit to provide a print at a pre-set position on the packaging material is performed repeatedly for each reference feature passing the printing unit.

13. The method according to claim 10, wherein activating the printing unit comprises activating a plurality of laterally distributed printing devices, each printing device being configured to provide a print at a unique pre-set position.

14. The method according to claim 10, wherein determining the actual lateral distance is performed by activating a plurality of laterally distributed detecting devices, each detecting device being configured to determine the actual lateral distance between a unique reference position and a provided print.

15. A method for manufacturing a packaging material, comprising:
feeding a web of packaging material through a décor printing system thereby providing the packaging material with a décor, and subsequently providing a print to the packaging material by performing the method according to claim 10.
